(19) United States
(12) Patent Application Publication
(10) Pub. No.: US 2016/0016524 A1
(43) Pub. Date: Jan. 21, 2016

(54) SYSTEM FOR PROVIDING ELECTRICAL CONDUCTOR PATHWAY TO A VEHICLE STEERING WHEEL

(71) Applicant: SYMTEC, INC., Fridley, MN (US)

(72) Inventors: Joseph D. Copley, Shakopee, MN (US); Joseph C. Bauer, Lindstrom, MN (US); Riley T. Harlan, Long Lake, MN (US)

(21) Appl. No.: 14/719,669

(22) Filed: May 22, 2015

Related U.S. Application Data
(60) Provisional application No. 62/002,262, filed on May 23, 2014.
(60) Provisional application No. 62/005,080, filed on May 30, 2014.

(51) Int. Cl. B60R 16/02; F16L 3/08; B60R 16/03; B62D 1/04; B62D 1/06

(52) U.S. Cl. CPC B60R 16/0215; B62D 1/046; B62D 1/06; B60R 16/03; F16L 3/08

(57) ABSTRACT

The present invention is directed to systems for providing a pathway for at least one electrical conductor from a power source to a steering wheel comprising at least one working element therein or thereon. The working element of the steering wheel may comprise an exemplary heating element to which the electrical conductor(s) connect. Alternatively, the steering wheel may comprise controllers for vehicle functions, e.g., radio, telephone and the like to which the electrical conductor(s) connect. More specifically, several embodiments of the invention comprise an electrical conductor pathway from a power source and on/off switch through the steering column to exemplary steering wheel heating elements with accommodation for the continuous winding and unwinding that occurs when the steering wheel is turned relative to the steering column which remains stationary.

### CROSS-REFERENCE TO RELATED APPLICATIONS

This application claims priority to App. Ser. No. 62/002,262, entitled “Mechanism for Electrical Conductor Pathway to Steering Wheel in a Vehicle,” filed May 23, 2014, and to App. Ser. No. 62/005,080, entitled “Mechanism for Electrical Conductor Pathway to Steering Wheel in a Vehicle,” filed May 30, 2014, the entire contents of each of which are hereby incorporated by reference.

### FIELD OF THE INVENTION

The present disclosure generally relates to systems for providing a pathway for at least one electrical conductor from a power source to a steering wheel of a vehicle.

### DESCRIPTION OF THE RELATED ART

A variety of devices and systems have been developed for providing comfort in heating steering wheels. A primary problem exists in many of these solutions. For most, the wire connecting a power source to the heating element in the steering wheel must pass through the stationary steering column. This creates an immediate problem because the steering wheel itself must turn relative to the stationary steering column. As a result, it is common to have problems managing the wire as it moves with the continually rotating steering wheel.

### BRIEF SUMMARY OF THE INVENTION

The present invention is directed to systems for providing a pathway for at least one electrical conductor from a power source to a steering wheel. The steering wheel may comprise a heating element to which the electrical conductor(s) connect. Alternatively, the steering wheel may comprise controllers for vehicle functions, e.g., radio, telephone and the like to which the electrical conductor(s) connect. More specifically, several embodiments of the invention comprise an electrical conductor pathway from a power source and on/off switch through the steering column to the steering wheel heating elements. One primary problem with existing heated steering wheels is that the electrical conductor elements can have difficulty accommodating the continuous winding and unwinding that occurs when the steering wheel is turned relative to the steering column which remains stationary. The present invention addresses this, among other, deficiencies in the known art.

### BRIEF DESCRIPTION OF THE DRAWINGS

FIG. 1 illustrates a perspective view of an assembly according to one embodiment of the present invention;

FIG. 2 illustrates a side cross-sectional view of the assembly illustrated in FIG. 1;

FIG. 3 illustrates a perspective view of one embodiment of the rotating and stationary elements assembly;

FIG. 4A illustrates a cutaway, cross-sectional view of one embodiment of the present invention;

FIG. 4B illustrates a cutaway, cross-sectional view of one embodiment of the present invention; and

FIG. 5 illustrates a schematic of an electrical conductor pathway of the present invention.

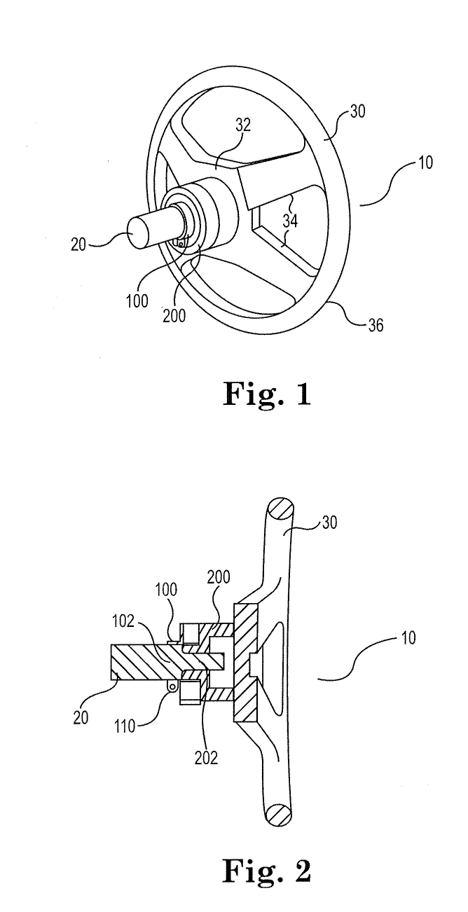

### DETAILED DESCRIPTION

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

Initially, it is to be understood that the various embodiments disclosed herein apply to motorized vehicles having a steering wheel. Generally, this includes land-based and water-based vehicles. Thus, for example, and without limitation, vehicle as used herein applies equally to cars, trucks, boats, planes, as well as off-road vehicles such as all-terrain vehicles (ATV) and utility vehicles (UTV). A preferred vehicle comprises ATV and UTV vehicles.

As illustrated in the Figures, generally, the disclosed system comprises a mechanism for providing at least one electrical conductor, e.g., a wire(s), pathway from a power source, e.g., a battery, to the vehicle steering wheel. Known heating elements may be used on or within the steering wheel to create the desired warming. See, e.g., U.S. Pat. Nos. 2,392,539; 3,165,620; and 5,847,360, each incorporated by reference in their entirety.

More specifically, a preferred embodiment provides an assembly 10 comprising a stationary element 100 to be used in operational engagement with a rotational element 200 to achieve the desired management of the electrical conductor(s) during the vehicle's steering operation. The stationary element 100 will be fixed to the steering column 20 of the vehicle and, therefore, will not rotate during the steering operation. The rotational element 200 is engaged with the stationary element 100 and is capable of rotating about the stationary element 200, and relative to the steering column 20 of the vehicle, during the steering operation. The rotational element 200 is operatively attached to and, therefore, rotates concurrently with the vehicle's steering wheel 30.

The steering wheel 30 is a generally known structure and, therefore, may comprise a central portion 32 connected to the rotational element 200 and at least one spoke 34 that connects to the central portion 32 and an outer wheel portion 36. As is known in the art, at least one of the spokes 34 may comprise a channel therethrough, not shown, which is in communication with at least one working, e.g., heating, element, also not shown but as is well known, that may be mounted in or on the outer wheel portion 36 of the steering wheel 30. Alternate mechanisms and methods for mounting working elements, e.g., controllers and/or creating the heating warmth of the steering wheel will become readily apparent to the skilled artisan. Each such mechanism and method may be used in combination with the disclosed conductor pathway of the present invention.

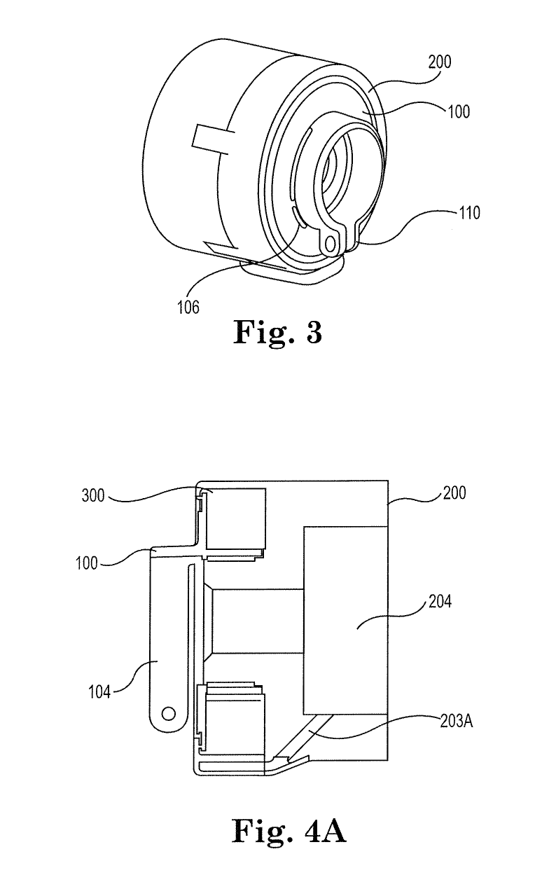

As is best seen in FIGS. 2-4, the stationary element 100 and the rotational element 200 comprise a stationary element lumen 102 and a rotational element lumen 202, respectively. The lumens 102, 202 are in operational communication and, thereby engage the steering column 20, with the stationary element lumen 102 fixed non-rotationally to the steering column 20 and the rotational element lumen 202 rotationally disposed in relation to the steering column 20 and the stationary element 100.

A steering column clamp 104 is provided on stationary element 100 to non-rotationally affix the stationary element 100 to the steering column. In addition, stationary element 100 further comprises a guiding slot 104 therethrough that is radially offset from the stationary element lumen.

An annular channel 300 is defined by the housing of rotational element 200 and the housing of stationary element 100, annular channel 300 in operational communication with the guiding slot 104.

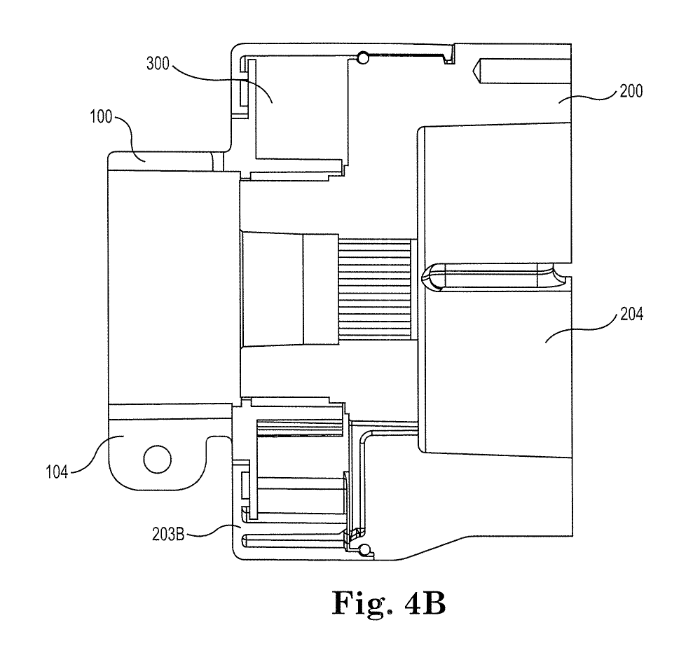

The rotational element 200 further comprises an aperture 203A (angled as in FIG. 4A) or 203B (straight as in FIG. 4B) that is in operational communication with the annular channel 300, and an accommodation space 204 defined within the housing of the rotational element 200. The accommodation space 204 is a relatively large space located proximal to the steering column and provides an area for the at least one electrical conductor to have relatively free motion and provides accommodation for the conductor(s) during the continuous steering operation. The accommodation space 204 is in operational communication with the aperture 203A or 203B and with the central portion 32 of the steering wheel 30, specifically with a channel or other means within the central portion 32 that, as described above, enables the electrical signal to pass from the rotational element 200 to the steering wheel 30, more specifically through at least one spoke 34 to the outer rim 36 of steering wheel 30 to a heating or other working element(s).

The skilled artisan will recognize that the systems and methods described herein are not limited to providing pathways for heated steering wheel conductors. Other working elements of the vehicle may be controlled from the steering wheel and, therefore, are amenable to electrical connection using the described electrical conductor(s) pathway. For example, and without limitation, radio, telephone, internet, seat movement, seat heating may all be controlled from the steering wheel and may use the described systems and methods to connect with the controlling actuators on the steering wheel.

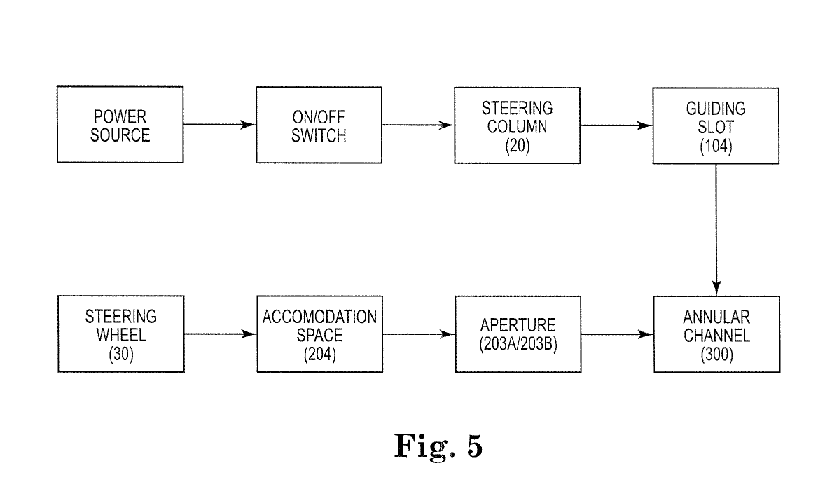

Thus, as best shown in the schematic of FIG. 5, an exemplary pathway for at least one electrical conductor from a power source to a vehicle steering wheel comprises:

providing a power source, e.g., a vehicle battery or a separate stand-alone battery;

connecting the at least one electrical conductor to the power source;

providing an on/off switch as is well known in the art to turn the power on/off;

pathing the at least one electrical conductor within or along the vehicle's stationary steering column;

pathing the at least one electrical conductor through the guiding slot 106 of the stationary element 100;

pathing the at least one electrical conductor from the guiding slot 106 through the annular space 300 defined by the housings of the stationary element 100 and the rotational element 200;

pathing the at least one electrical conductor from the annular space 300 through aperture 203A, 203B of the rotational element 200;

pathing the at least one electrical conductor from the aperture 203A, 203B, to the larger accommodation space 204 of the rotational element 200; and

further pathing or connecting the at least one electrical conductor from the accommodation space to the working, e.g., heating, element of the steering wheel 30.

As described, the systems and methods disclosed may be used to provide a pathway for at least one electrical conductor from a power source to a vehicle steering wheel to connection with any working element or application implemented thereon. For example, a switch to turn off the heated steering wheel may be disposed on the steering wheel itself. Further, radio controls, telephone and other connectivity controls, heated seat controls and the like may also be disposed on the steering wheel and controllable using the electrical conductor(s) pathway systems and methods described herein.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A system for providing an electrical conductor pathway from a power source to a working element located on or in the steering wheel of a vehicle, comprising:
a stationary element having a housing and in non-rotational connection with a steering column of the vehicle;
a rotational element having a housing and connected with the steering wheel and in rotational engagement with the stationary element and the steering column;
an annular space defined by the stationary element housing and the rotational element housing and capable of receiving at least one electrical conductor therein;
the stationary element further comprising
a steering column clamp fixed to the steering column;
a stationary element lumen capable of receiving at least a portion of the steering column and
a guiding slot radially offset from the stationary element lumen, the guiding slot in operative communication with the annular space and capable of receiving the at least one electrical conductor therethrough;
the rotational element further comprising
a rotational element lumen capable of receiving at least a portion of the steering column and in rotational engagement with the received portion of the steering column;
an aperture in operative communication with the annular space, the aperture capable of receiving the at least one electrical conductor therein; and
an accommodation space in operative communication with the aperture, the accommodation space capable of receiving the at least one electrical conductor therein and wherein the accommodation space is in operative communication with a working element on or in the steering wheel.

2. The system of claim 1, wherein the working element comprises at least one of the group consisting of: a radio controller, internet controller, telephone controller, and seat heating controller.

3. The system of claim 1, wherein the working element comprises a steering wheel heating element.

4. A system for connecting a power source with a heating element in a steering wheel, comprising:
a steering wheel comprising a steering column and a heating element;
a stationary element having a housing and in non-rotationally connection with the steering column of the vehicle;
a rotational element having a housing and connected with the steering wheel and in rotational connection with the stationary element;
an annular space defined by the stationary element housing and the rotational element housing and capable of receiving at least one electrical conductor therein;
the stationary element further comprising
a steering column clamp fixed to the steering column;
a stationary element lumen capable of receiving the steering column and
a guiding slot radially offset from the stationary element lumen, the guiding slot in operative communication with the annular space and capable of receiving the at least one electrical conductor therethrough;
the rotational element further comprising
a rotational element lumen in operative communication with the stationary element lumen;
an aperture in operative communication with the annular space, the aperture capable of receiving the at least one electrical conductor therein; and
an accommodation space in operative communication with the aperture, the accommodation space capable of receiving the at least one electrical conductor therein and wherein the accommodation space is in operative communication with the heating element.

5. The system of claim 4, further comprising an on/off switch in operative communication with the power source and the heating element.
